(19) United States
(12) Patent Application Publication
(10) Pub. No.: US 2016/0082457 A1
(43) Pub. Date: Mar. 24, 2016

(54) HUMAN HYDRATION SYSTEM

(71) Applicant: John Niehaus, Indianapolis, IN (US)

(72) Inventor: John Niehaus, Indianapolis, IN (US)

(21) Appl. No.: 14/862,950

(22) Filed: Sep. 23, 2015

Related U.S. Application Data
(60) Provisional application No. 62/054,171, filed on Sep. 23, 2014.

(51) Int. Cl. B05B 11/00

(52) U.S. Cl. CPC B05B 11/3028; B05B 11/3047

(57) ABSTRACT

A hydration system includes a hydration reservoir, a fluid transport tube having a first end at least partially extending into the hydration reservoir, and a fluid delivery portion in fluid communication with a second end of the fluid transport tube. A fluid delivery pump can selectively flow a portion of a hydration fluid from the hydration reservoir through the fluid transport to a fluid delivery portion and into the oral cavity of a user.

### CROSS REFERENCE TO RELATED APPLICATIONS

The present applications claims the benefit of U.S. Provisional Application Ser. No. 62/054,171 filed on Sep. 23, 2014, which is incorporated by reference herein in its entirety.

### BACKGROUND

The present invention relates generally to human hydration and more particularly, to a system for hydrating humans at regular intervals during various type of

Staying properly hydrated is important to a successful exercise regime or for any activity for that matter. Existing hydration systems require a user to momentarily direct their attention away from the task at band when they wish to take in fluids. In many instances, this presents danger or momentarily impedes performance (e.g.—while cycling). Typically, the user is required to use at least one hand to retrieve a water bottle or hose when they wish to take in liquids thus distracting the user.

People tend to wait until they are dehydrated before inking in liquids, which affects performance and has potential serious health implications. After consuming liquids when dehydrated, or any time for that matter, it takes time for the fluid to provide relief to the user and refuel the body. After liquid is taken in, hydration levels in the blood do not peak until about twenty minutes later. This compounds the negative effect of waiting too long to take in fluids. Further, when a user waits too long to take in fluid, the fluid will frequently be consumed in a wasteful manner.

To that end, a need exists for a human hydration system that addresses all of the issues set forth above.

### SUMMARY

One embodiment of the present application includes a personal hydration apparatus. Other embodiments include unique hydration apparatuses, systems, and methods. Further embodiments, inventions, terms, objects, features, advantages, aspects, and benefits of the present application are otherwise set forth or become apparent from the description and drawings included herein.

### BRIEF DESCRIPTION OF THE DRAWINGS

The description herein makes reference to the accompanying drawings wherein like reference numerals refer to like parts throughout the several views, and wherein:

FIG. 1 illustrates a fluid hydration system.

FIG. 2 illustrates a fluid delivery portion of the fluid hydration system.

FIG. 3 is another view of fluid hydration system illustrating a pump.

FIG. 4 is a view of the pump of the fluid hydration system.

### DESCRIPTION OF ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any such alterations and further modifications in the illustrated devices, and such further applications of the principles of the invention as illustrated herein are contemplated as would normally occur to one skilled in the art to which the invention relates.

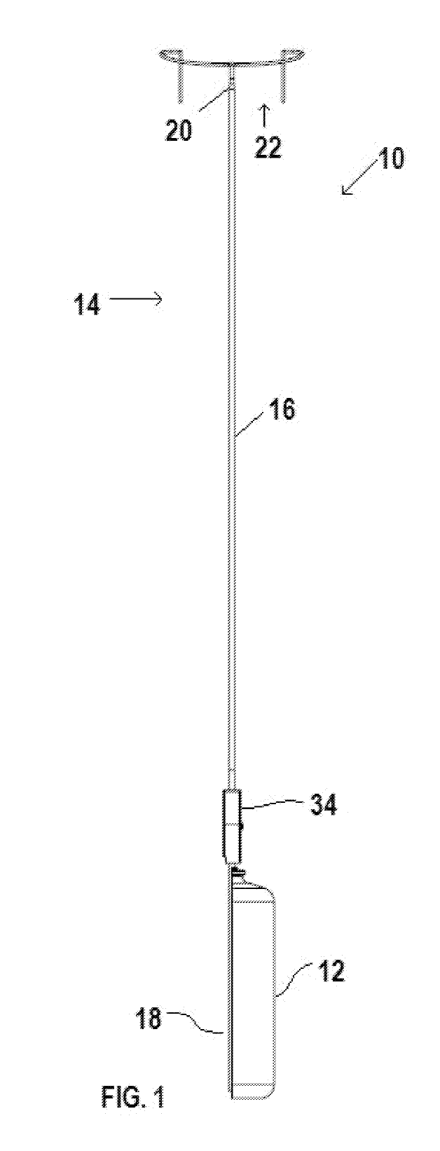

Referring to FIG. 1, a human hydration system 10 is illustrated that is configured to provide fluid to a human during any type of physical activity. The hydration system 10 includes an automatic peristaltic metering pump 34 that delivers fluid via a tube set 14 including a portion that resides comfortably in the user's mouth 22. As set forth in greater detail below, in some forms the amount of fluid delivered anther the timing of the delivery is controlled thereby ensuring that the user maintains a proper level of hydration at all times.

The hydration system 10 includes a reservoir 12 that is configured to store fluid. In one form, the reservoir 12 comprises a plastic bottle. In other forms it is contemplated that other types of fluid containers could be used with the present invention, including but not limited to a flexible bladder type reservoir. A delivery tube set 14 is included that is connected with the reservoir 12. The delivery tube set 14 includes a fluid transport tube 16 having a distal end 18 extending downward into the reservoir 12. In one form, the fluid transport tube 16 comprises of flexible tube. In some uses, such as cycling, the example, the deliver tube 16 can be positioned along the back of the user.

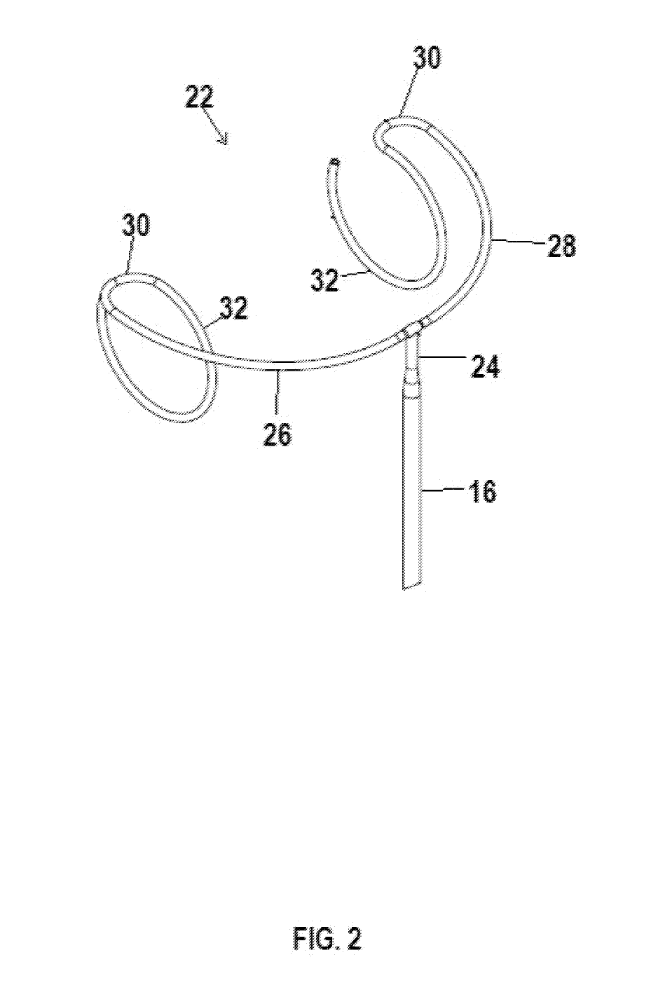

A proximal end 20 of the fluid transport tube 16 is connected with a fluid delivery portion 22 which is configured to comfortably rest within the mouth of a user. Referring now in FIG. 2 fluid delivery portion 22 includes a joint that is connected with the proximal end 20 of the fluid transport tube 16. In one form, the joint 24 comprises a T-joint that is configured to divide the flow of fluid from the fluid transport tube 16 into two fluid paths. As illustrated, the joint 24 includes a first output that is connected with a first fluid leg 26. A second output of the joint 24 is connected with a second fluid leg 28.

During use, the joint 24 would rest at the base of a user's neck. As such, the joint 24 serves as a neck lanyard that can be used to carry weight and resist dynamic pull of the vertical run of the fluid transport tube 16. In other forms, a separate lanyard (not shown) can be worn around a user's neck to support the vertical run of the fluid transport tube 16. The first and second fluid legs 26, 28 can comprise flexible tubing that is bendable, yet retains its form. As illustrated, an end portion of the first and second legs 26, 28 include a U-shaped portion 30 that extends inwardly and a generally circular shaped or curled portion 32 that extends back and away from the U-shaped portion 30.

An end of the curled portion 32 includes one or more outlets or apertures for fluid to be dispensed into the oral cavity of a user. The curled portion 32 and the U-shaped portion 30 are sized and configured to fit in the mouth of the user. In particular, a portion of the U-shaped portion 30 fits between the ends of the lips of the user and the circular shaped portion 32 as between the user's teeth and cheeks. The circular shaped portion 32 and the U-shaped portion 30 may take other forms in other embodiments of the invention that allow the tubes to be retained within the user's mouth. As the tube remains in the mouth of the user for the duration of the activity, fluid is delivered in a hands-free manner. In addition, the user is also able to speak with the tubes in place, thereby allowing effective communication as needed.

To insert the fluid delivery portion 22, a user can insert the U-shaped portion 30 into a corner at the end of the mouth of the user, the corner being defined by the connection of the upper and lower lip. The user can further place the curled portion 32 between the cheek and teeth. The user can then attach the opposite U-shaped portion 30 and curled portion 32 in the opposite side of the mouth. The flexibility of the tubing 26, 28 permits the case o installation of the fluid delivery portion 22 and comfort or the user during wear.

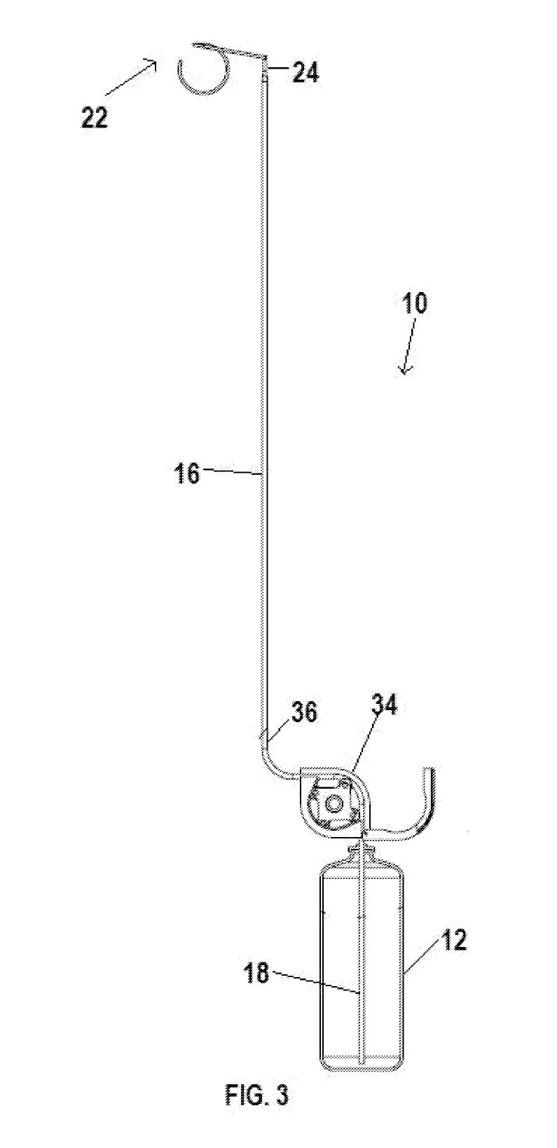

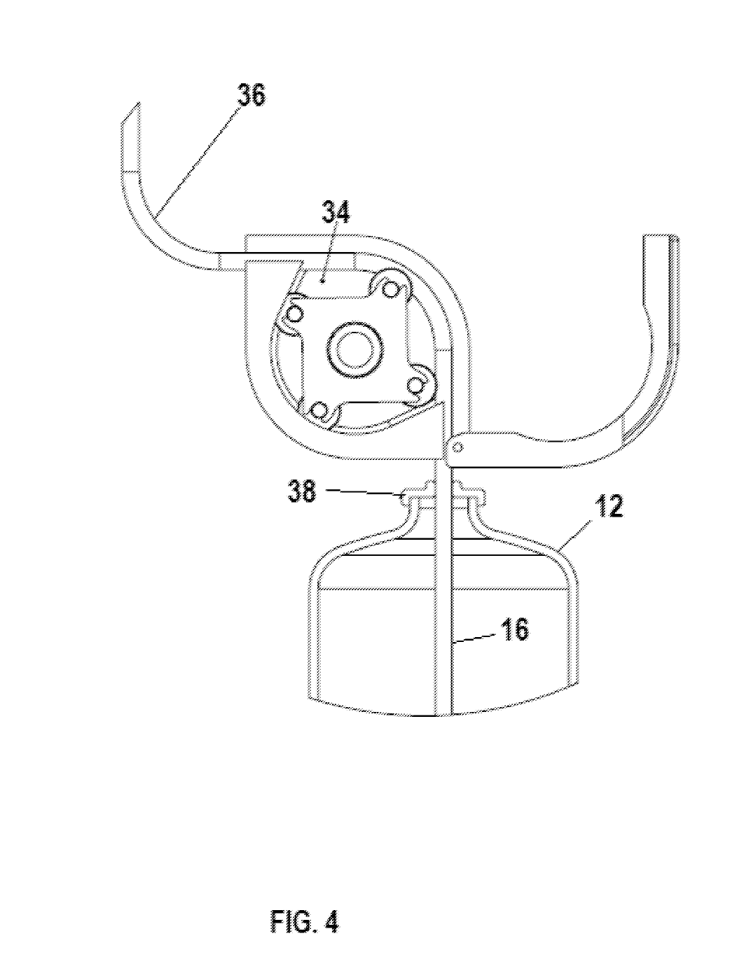

Referring to FIGS. 3 and 4, the hydration system 10 includes a pump 34 that is connected with the fluid transport tube 16. In the illustrated form, the pump 34 is a peristaltic pump. The pump 34 draws fluid from the reservoir 12, propels the fluid through the fluid transport tube 16, and ultimately dispensed through the first and second legs 26, 28. With the use of a peristaltic pump, nothing comes into contact with the fluid thereby maintaining the purity of the fluid. A quick disconnect 36 may be connected between an output of the pump 34 and the fluid transport tube 16. In one form, the quick disconnect 36 may comprise a Leer Lock or similar device. The top of the reservoir 12 may include a seal 38 through which the fluid transport tube 6 extends into the reservoir 12.

The pump 34 can be controlled in several different configurations. In one form, the pump 34 could be an electrically driven pump with a fully programmable operating system (“OS”). The OS would allow input of personal variables such as user weight, type of activity, or other personal variables that would affect the rate of delivery required. The system can automatically measure temperature, relative humidity, and other environmental variables as needed to compute the required rate of delivery of the fluid. The personal variables can be saved under a user name or profile for future use. Optionally, the system would employ a suitable exertion sensor such as a heart rate monitor to adjust delivery according to changing demand. A manual offset function could be provided to adjust the computed rate as needed or desired. Delivery could be at constant time intervals with variable volume, constant volume delivered at variable time intervals, or a continuous trickle. Alternatively, the computation and data storage functions described above could be implemented as a smart phone app and downloaded to the hydration system via Bluetooth functionality.

In another form, the pump 34 could be an electrically driven pump with simple rate of adjustments for rate of delivery. As set forth above, delivery could be at constant lime intervals with variable volume, constant volume delivered at variable time intervals, or a continuous trickle. The pump 34 could also be a mechanically driven pump that is driven by a windup spring motor and provided with a suitable mechanism to allow for adjustment of rate of delivery. In yet another form, the pump 34 could be a manual pump that would require operation of a lever or hand grip to dispense liquid.

As illustrated the pump 34 can be located on the reservoir 12. In further forms it is contemplated that the pump 34 Can be located remotely from the reservoir 12 such as on a bicycle frame, on a utility belt or pack, attached to webbing on a pack, or the like.

Although various embodiments have been described as having particular features and/or combinations of components, other embodiments are possible having a combination of any features and/or components from any of embodiments as discussed above. As used in this specification, the singular items “a,” “an” and “the” include plural referents unless the context clearly dictates otherwise.

While the invention has been illustrated and described in detail in the drawings and foregoing description, the same is to be considered as illustrative and not restrictive in character, it being understood that all changes and modifications that come within the spirit of the invention are desired to be protected.

What is claimed is:

1. A personal hydration system, comprising:
a hydration reservoir configured to bold a hydrating fluid;
a fluid transport tube including a first end and as second end, wherein the first end is in fluid communication with the hydration reservoir, and wherein the second end terminates at a fluid delivery portion, wherein the fluid delivery portion includes at least one aperture structured to permit the flow of the hydrating fluid therethrough; and
a pump in fluid communication with the hydration reservoir and the fluid transport tube, wherein the pump is structured to pump a portion of the hydrating fluid from the hydration reservoir through the fluid transport tube to the fluid delivery portion.

2. The personal hydration system of claim 1, wherein the fluid delivery portion is further structured to be retained within an oral cavity of a user.

3. The personal hydration system of claim 2, wherein the fluid delivery portion further includes a flow divider structured to divert the hydration fluid into a first fluid leg and a second fluid leg, wherein a first terminus or the first fluid leg is structured to be retained against an interior portion or a left cheek of a user, and wherein a second terminus of the second fluid leg is structured to be retained against an interior portion of a right check of a user.

4. The personal hydration system of claim 1, further comprising a quick disconnect located in a portion of the fluid transport tube at a position upstream from the pump.

5. The personal hydration system of claim 1, wherein the pump further comprises a peristaltic pump.

6. The personal hydration system of claim 5, wherein the pump further comprises an electrically driven pump.

7. The personal hydration system of claim 6, wherein the pump further includes a programmable operating system, and wherein the pump is structured to meter a flow of the hydration fluid in response to at least one of user weight, type of activity, measured ambient temperature, and relative ambient humidity.

8. The personal hydration system of claim 6, wherein the pump is a variable flow rate pump, wherein a use can adjust at least one of a hydration fluid flow rate and a time between hydration fluid flow.

9. A personal hydration apparatus, comprising:
a fluid transport tube including a hydration fluid inlet and a hydration fluid outlet, wherein the hydration fluid inlet is structured to be placed in fluid communication with a portion of hydration fluid in a hydration reservoir; and
a pump structured to flow a portion of the hydration fluid from the hydration reservoir through the fluid transport tube to the hydration fluid outlet, wherein the hydration fluid outlet is structured to be placed in flow communication with an oral cavity of a user.

10. The personal hydration apparatus of claim 9, wherein the hydration fluid outlet further comprises a fluid delivery portion, and wherein the fluid delivery portion further comprises means for retaining the fluid delivery portion within the oral cavity of the user.

11. The personal hydration apparatus of claim 9, wherein the pump is at least one of mechanically driven and electrically driven.

12. The personal hydration apparatus of claim 9, wherein the pump further comprises an electrically driven peristaltic pump.

13. The personal hydration apparatus of claim 12, wherein the pump further comprises means for varying a varying hydration fluid.

14. The personal hydration apparatus of claim 9, further comprising a quick disconnect located between an output of the pump and the fluid transport tube.

15. A hydration apparatus, comprising:
a hydration reservoir structured to store a hydration fluid:
a fluid transport tube having a first end and a second end, wherein the first end at least partially extends into the hydration reservoir;
a fluid delivery portion in fluid communication with the second end, wherein the fluid delivery portion is further structured to permit the release of the hydration fluid into the oral cavity of a user; and
a fluid delivery pump structured to flow a portion of the hydration fluid to the fluid delivery portion.

16. The hydration apparatus of claim 15, wherein the fluid delivery portion is structured to be retained within an oral cavity of a user.

17. The hydration apparatus of claim 16, wherein the fluid delivery portion further fluid includes a flow divider structured to divert the hydration fluid into a first fluid leg and a second fluid leg, wherein a terminus of the first fluid leg is structured to be retained against an interior portion of a left cheek of a user, and wherein a terminus of the second fluid leg is structured to be retained against an interior portion of a right cheek of a user.

18. The hydration apparatus of claim 15, wherein the fluid delivery pump further comprises an electrically driven peristaltic pump.

19. The hydration apparatus of claim 18, wherein the fluid delivery pump is electronically controlled, and wherein the fluid delivery pump is structured to vary a rate of delivery of the hydration fluid in response to at least one of environmental variables and user selected personal variables.

20. The hydration apparatus of claim 15, wherein the fluid delivery pump is mounted remotely from the hydration reservoir.
